(19) United States
(12) Patent Application Publication
(10) Pub. No.: US 2009/0230786 A1
(43) Pub. Date: Sep. 17, 2009

(54) Linear Power-Generating Apparatus

(76) Inventor: Chin-Sung Liu, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/048,203

(22) Filed: Mar. 13, 2008

(51) Int. Cl. H02K 35/00

(52) U.S. Cl. 310/15

(57) ABSTRACT

A linear power-generating apparatus is provided, including a column element having permanent magnetic field, and a coil set surrounding the column element. The column element includes a plurality of permanent magnetic segments and a plurality of yokes placed between two neighboring permanent magnetic segments. The magnetic segments are arranged in the manner that the same polar ends are facing each other. The coil set includes a plurality of coils. The winding directions of two neighboring coils are opposite. The linear power-generating apparatus of the present invention can induce electromotive force in the coil set to generate power by using the linear back-and-forth relative motion between the column element and the coil set. In the constant speed relative motion, the linear power-generating apparatus of the present invention can generate a near-constant direct current (DC) voltage.

### FIELD OF THE INVENTION

The present invention generally relates to a power-generating apparatus, and more specifically to a power-generating apparatus by using the linear relative motion between permanent magnetic field and the coil.

### BACKGROUND OF THE INVENTION

The conventional power-generating apparatus relies on the relative motion between the permanent magnetic field and the coil to induce the electromotive force in the coil to generate power. The permanent magnetic field is usually generated by arranging the permanent magnets in a ring, and the electromotive force induction is accomplished by rotating the coil inside the permanent magnets ring. This type of conventional power-generating apparatus is widely used in the daily, and various improvements in power generation efficiency are disclosed. However, one remaining major disadvantage of this type of power-generating apparatus is the bulky size, and another disadvantage is the power generated is usually alternating current (AC).

### SUMMARY OF THE INVENTION

The present invention has been made to overcome the above-mentioned drawback of conventional power-generating apparatus of bulky size and AC-only power generation. The primary object of the present invention is to provide a power-generating apparatus that is small in size and able to generate direct current (DC). The present invention provides a power-generating apparatus by using a linear, instead of rotation, relative motion to generate power.

The linear power-generating apparatus of the present invention includes a column element having permanent magnetic field, and a coil set surrounding the column element. The column element includes a plurality of magnetic segments, with one end as N and the other as S, and a plurality of yokes placed between two neighboring magnetic segments. The magnetic segments are arranged in the manner that the same polar ends are facing each other; in other words, N to N, and S to S. The coil set includes a plurality of coils. The winding directions of two neighboring coils are opposite. The linear power-generating apparatus of the present invention can induce electromotive force in the coil set to generate power by using the linear back-and-forth relative motion between the column element and the coil set. In the constant speed relative motion, the linear power-generating apparatus of the present invention can generate a near-constant direct current (DC) voltage.

As the linear power-generating apparatus of the present invention uses linear relative motion, the size of the apparatus can be minimized. In addition, the reverse magnetic arrange of the permanent magnets, i.e., S-S and N-N, allow the full segment of every coil of the coil set to generate power; therefore, the power generation efficiency is high.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1a shows a perspective view of an embodiment of the linear power-generating apparatus of the present invention;

FIG. 1b shows an exploded view of the embodiment of FIG. 1a;

FIGS. 2a, 2b show a side perspective view of the relative motion between column element and coil set of FIG. 1a;

FIG. 3a shows the relation between magnetic flux Φ_{BL} of permanent magnet versus axis distance L;

FIG. 3b shows the relation between total magnetic flux Φ_{B} of permanent magnet versus axis distance L;

FIG. 3c shows the relation between differential

$$\frac{d {Φ}_{B}}{d L}$$

of total magnetic flux Φ_{B} in regard of axis distance L of permanent magnet versus axis distance L; and

FIG. 3d shows the relation between induced electromotive force ε of coil at constant speed relative motion versus axis distance L.

### DETAILED DESCRIPTION OF THE PREFERRED EMBODIMENTS

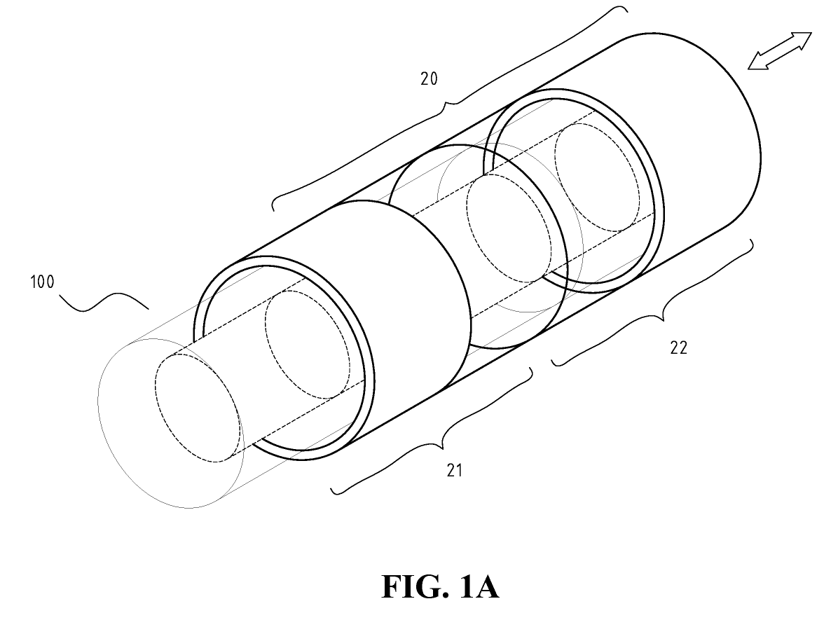

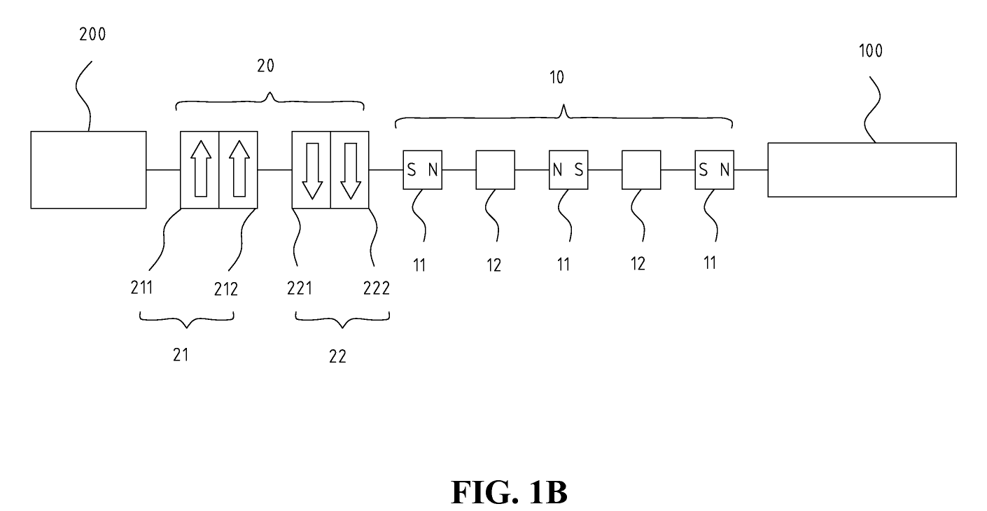

FIGS. 1a and 1b show a perspective view and an exploded view of an embodiment of the linear power-generating apparatus of the present invention. As shown in the figures, the present embodiment includes a column element 10 and a coil set 20. Column element 10 provides the permanent magnetic field, and the linear back-and-froth relative motion between column element 10 and coil set 2—along the axis of column element 10, shown as the arrow in FIG. 1a, will induce the electromotive force in coil set 20, and generate power.

Column element 10 includes at least two segments of permanent magnets 11 and at least a segment of yoke 12, arranged linearly in an end to end manner. A yoke 12 is placed between any two neighboring permanent magnets 11. It is worth noting that one end of permanent magnet is N pole, and the other end is S pole. In addition, any two permanent magnets 11 of column element 10 are arranged to have the same pole facing each other; that is, the two ends of yoke 12 between any two neighboring permanent magnets 11 will have the same pole, either S pole or N pole. This type of arrangement is usually called reverse magnetic arrangement. In the present embodiment, column element 10 is housed inside a tube sheath 100.

Coil set 20 is winding around a tube sheath 200. Tube sheaths 100, 200 can be made of any appropriate material that will not shield the magnetic field of permanent magnets 11. Also, tube sheath 200 should be made of insulative material, and has a diameter that is slightly larger than the diameter of tube sheath 100 so that tube sheath 100 can be inserted inside tube sheath 200, and the linear back-and-forth relative motion along the axis of the tube sheaths is allowed.

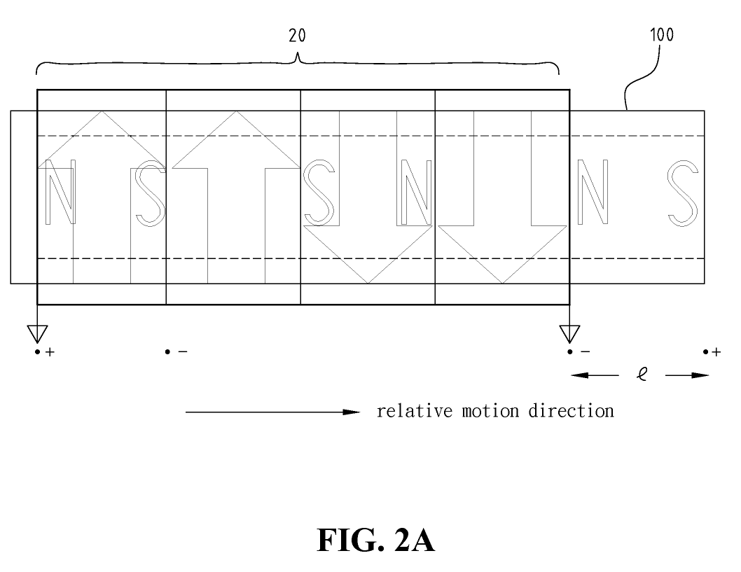

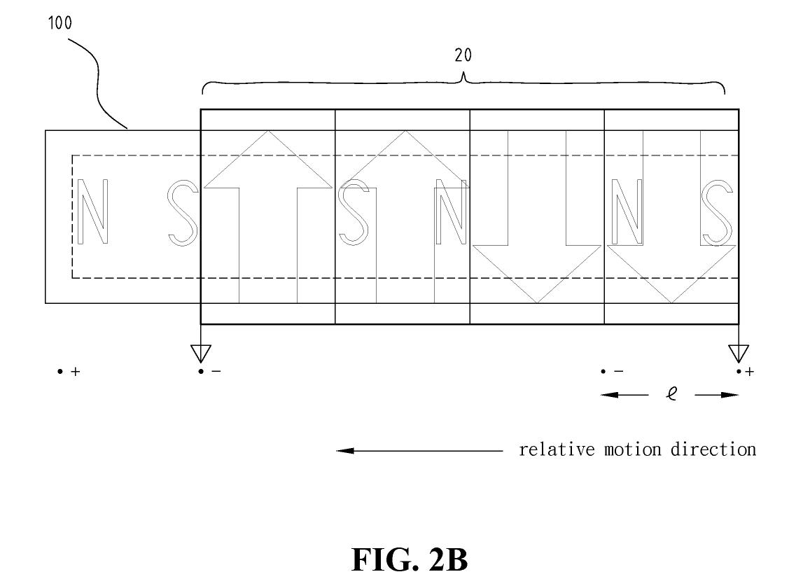

Coil set 20 includes at least two coils 21, 22 connected in series. It is worth noting that the winding directions of any two neighboring coils 21, 22 are the opposite of each other, as shown by the arrows in FIG. 1b. In addition, each coil 21, 22 can be divided into two coil segments 211, 212, or 221, 222. In the present embodiment, coil segments 211, 212, 221, 222 have approximately the same axis length l, which is also approximately the same length of the axis length of permanent magnets 11 and yoke 12, as shown in FIGS. 2a, 2b. In other words, the axis length of each coil 21, 22 is approximately twice the axis length of permanent magnet 11.

FIGS. 2a, 2b show a side perspective view of relative motion between column element 10 and coil set 20 of an embodiment of the present invention. It is worth noting that motion direction indicated by the arrows in the figures are for column element 10 to be stationary while for coil set 20 to move linearly in the direction. The similar linear relative motion can be accomplished by having coil set 20 to be stationary while having column element 10 to move in the reverse direction indicated by the arrows.

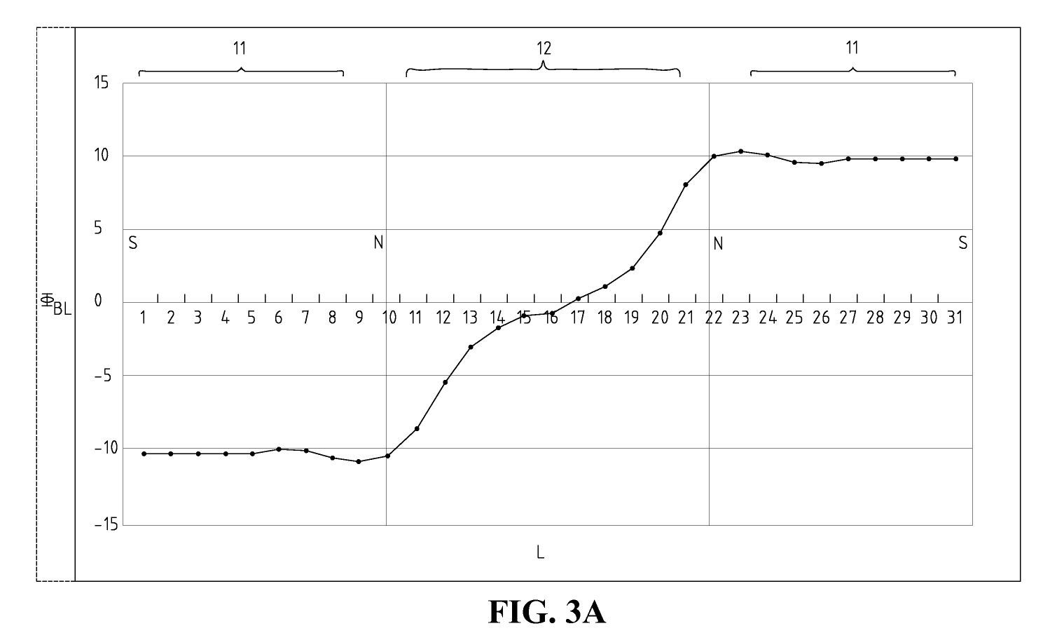

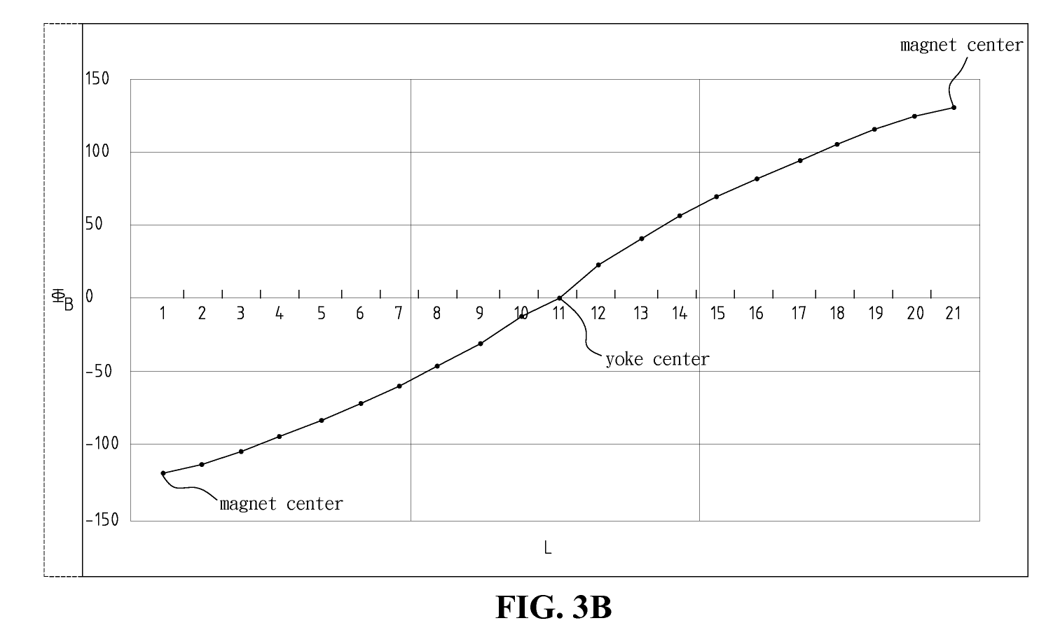

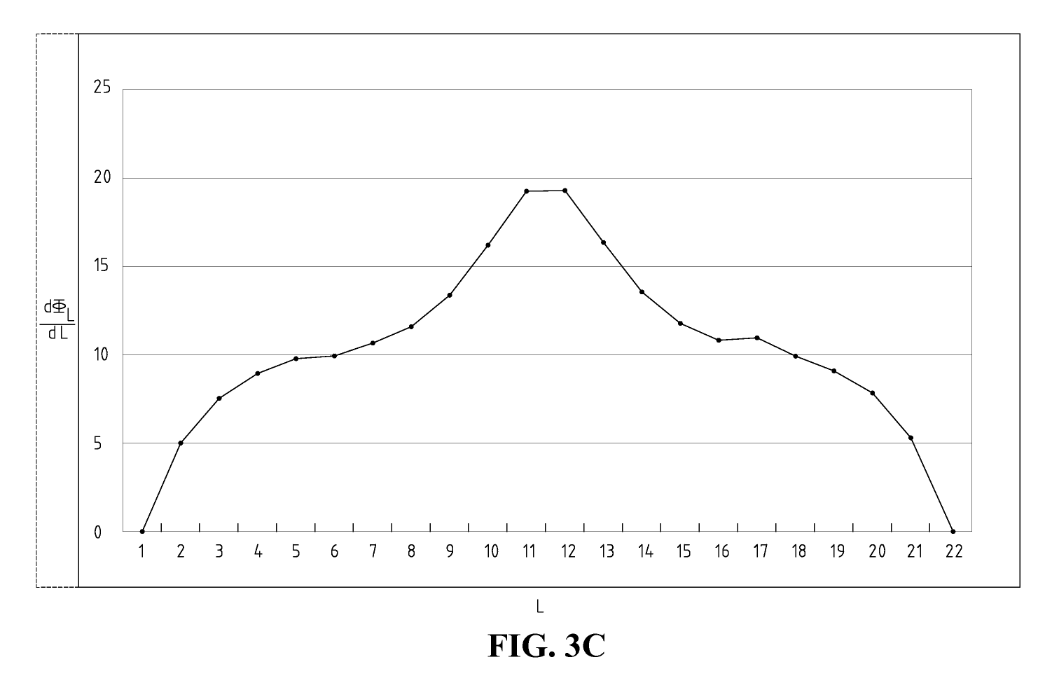

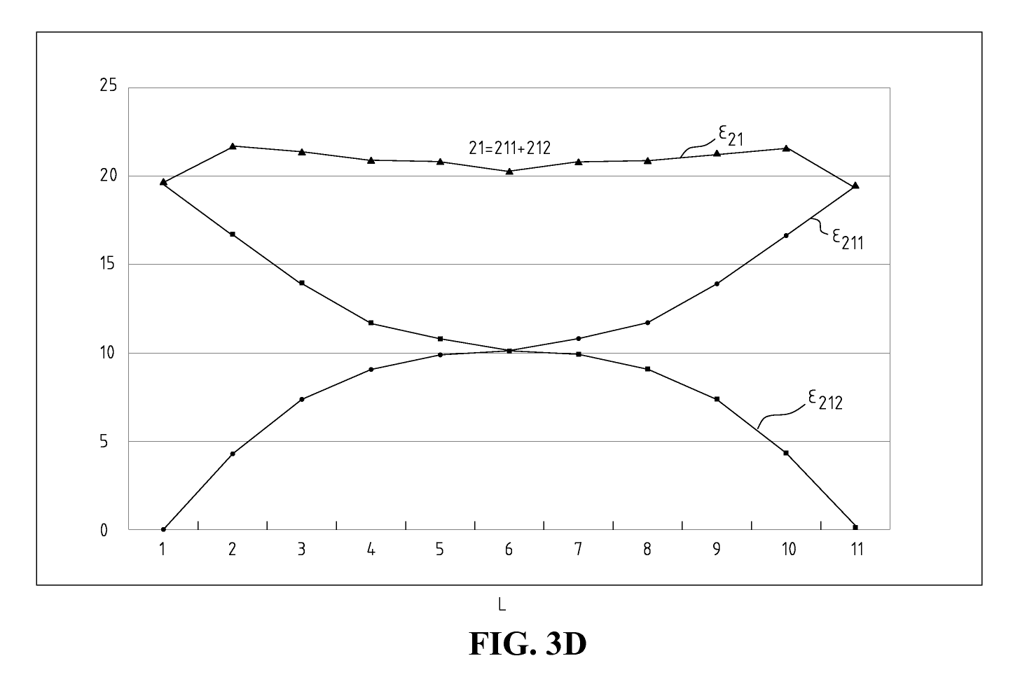

The theory behind the present invention is explained as follows. First, when no relative motion exists, magnetic flux Φ_{BL} generated by two permanent magnets 11 and a yoke 12 versus axis distance L is shown in FIG. 3a. FIG. 3b shows total magnetic flux Φ_{B} from the center of a permanent magnet 11 to the center of neighboring permanent magnet 11 versus axis distance L. The relation between magnetic flux Φ_{BL} and total magnetic flux Φ_{B} is as follows:

Φ_{B}=∫Φ_{BL}dL

When relative motion between column element 1 and coil set 20 occurs, coil set 20 is induced with an electromotive force ε, which has a relation with total magnetic flux Φ_{B} that can be derived by the following equation (where N is a constant):

$$\begin{matrix}ɛ = - N \frac{d {Φ}_{B}}{d t} \\ = - N \frac{d {Φ}_{L}}{d L} \frac{d L}{d t} \\ = - N \frac{d {Φ}_{B}}{d L} v\end{matrix}$$

In other words, the relation between electromotive force ε, speed v of the relative motion and differential

$$\frac{d {Φ}_{B}}{d L}$$

of total magnetic flux Φ_{B} in regard of axis distance L is proportional. Differential

$$\frac{d {Φ}_{B}}{d L}$$

of total magnetic flux Φ_{B} in regard of axis distance L can be derived from FIG. 3b, as shown in FIG. 3c.

Assuming that speed v of the relative motion is constant, i.e., the relative motion between column element 10 and coil set 20 is at a constant speed. According to the above equation, electromotive forces ε₂₁₁, ε₂₁₂ generated by coil segments 211, 212 and electromotive force ε₂₁=ε₂₁₁+ε₂₁₂ generated by coil 21 can be derived as in FIG. 3d. As shown in FIG. 3d, electromotive force ε₂₁ generated by coil 21 is almost a constant. Similarly, electromotive force ε₂₂ generated by coil 22 is almost a constant. Therefore, electromotive force ε=ε₂₁+ε₂₂ generated by coil set 20 is almost a constant. Hence, the generated voltage is a near constant DC voltage.

In summary, because the linear power-generating apparatus of the present invention uses linear relative motion, the size of the power-generating apparatus of the present invention can be much smaller than the size of a conventional rotating power-generating apparatus. Also, the reverse magnetic arrangement of the permanent magnets allows the entire coil segment of any coil to generate power. So, the power generation efficiency is high. Finally, when the relative motion is at a constant speed, the generated voltage is a near-constant DC voltage.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A linear power-generating apparatus, comprising:
a column element, further comprising a plurality of segments of permanent magnets and at least a yoke, one end of said permanent magnet segment being N pole, and the other end being S pole, a yoke being placed between two neighboring permanent magnets, said neighboring permanent magnets arranged to have same pole facing each other; and
a coil set, surrounding said column element, further comprising a plurality of coils connected in series, winding directions between two neighboring said coils being opposite to each other;
wherein a relative motion along axis between said column element and said coil set able to induce a direct current voltage in said coil set.

2. The apparatus as claimed in claim 1, wherein said column element is housed inside a first tube sheath having a diameter slightly smaller than the diameter of said coil set.

3. The apparatus as claimed in claim 1, wherein said coils are wound around an insulative second tube sheath having a diameter slightly larger than the diameter of said column element.

4. The apparatus as claimed in claim 1, wherein the axis length of each said coil is approximately twice as the axis length of said permanent magnet.
